(19) United States
(12) Patent Application Publication
(10) Pub. No.: US 2012/0159856 A1
(43) Pub. Date: Jun. 28, 2012

(54) PARENT MATERIAL PLUG/COVER

(75) Inventors: Wilfred Courchaine, Moore, SC (US); Eddie Kimbrell, Dacula, GA (US); Rene Franco, Greenville, SC (US)

(73) Assignee: AFL TELECOMMUNICATIONS LLC, Spartanburg, SC (US)

(21) Appl. No.: 13/062,562

(22) PCT Filed: Sep. 15, 2010
(86) PCT No.: PCT/US10/48943

§ 371 Date: Mar. 7, 2011

(30) Foreign Application Priority Data
Sep. 15, 2009 (US) 61242418

(51) Int. Cl. E06B 3/01; B23P 11/00

(52) U.S. Cl. 49/463; 29/592; 29/426.1

(57) ABSTRACT

Provided is a panel, the panel including a parent panel, a removable panel formed from the parent panel and configured to be removed from the parent panel, at least one tab portion which adjoins the removable panel to the parent panel, and at least one gap formed between the parent panel and the removable panel. The at least one gap extends around an outer periphery of the removable panel, except at the at least one tab portion.

### CROSS-REFERENCE TO RELATED APPLICATIONS

This application claims priority from U.S. Provisional Patent Application No. 61/242,418 filed Sep. 15, 2009 the disclosure of which is incorporated herein by reference in its entirety.

### BACKGROUND

1. Field of the Invention

Methods and apparatuses consistent with the present invention relate to a removable panel, and more particularly, a removable panel formed from the parent material of a parent panel, and, when removed, forms a panel opening within the parent panel.

2. Description of the Related Art

Panels, shelves and enclosures typically use round, square or rectangular openings to insert adapters and various other hardware into faceplates used in conjunction with various products. In the related art, these openings are generally plugged by various means when they are not yet populated with these adapters or other hardware. Accordingly, this methodology requires the added cost of supplying fill-in plugs or blanks secured by various fastening methods to cover these openings.

For example, FIGS. 1A-C illustrate the use of plug inserts and blank panel inserts to cover various openings in the related art. In particular, FIG. 1A shows cables 10 connected to fittings 12 which are populated in panel 14. In addition, openings 15 which are not yet populated with the connectors or other hardware are covered by round plug inserts 16.

FIG. 1 B shows rectangular panel plates 20 which are populated with adapters 22 and are placed over openings (not shown) formed in a back panel 24 such that a back portion (not shown) of the adapters 22 are inserted though the openings. The ends of the rectangular panel plates 20 extend past the openings and are laid over the back panel 24, and fasteners 26 attached near the ends of the rectangular panel plates 20 are fastened to the back panel 24 such that the rectangular panel plates 20 are fixed to the blank panel 24. In addition, a blank panel plate 28 is used to cover an opening which is not yet populated with a rectangular panel plate 20, and the blank panel plates 28 is attached to the back panel 24 by the fasteners 26.

FIG. 1C shows a rectangular panel opening 30 formed in a panel 32 and which is not plugged, another rectangular panel opening 30 which is plugged by a rectangular panel insert 34, and another rectangular panel opening 30 which has a device 38 disposed therein. The periphery of the rectangular panel insert 34 is configured to extend over a front portion of the panel 32, while a center portion of the rectangular panel insert 34 is configured to extend through the opening 30. Thus, the rectangular panel insert 34 may be used to plug an unpopulated opening 30.

Accordingly, as shown in FIGS. 1A-C, various types of fill-in plugs or blanks are supplied to cover or plug openings which may vary greatly in size, shape and application until the openings are populated with adapters or other hardware. The need for providing and securing these fill-in plugs and blanks leads to an increase in cost.

### SUMMARY

According to an aspect of the present invention, there is provided a panel which includes: a parent panel; a removable panel formed from the parent panel and configured to be removed from the parent panel; at least one tab portion which adjoins the removable panel to the parent panel; and at least one gap formed between the parent panel and the removable panel, the at least one gap extending around an outer periphery of the removable panel, except at the at least one tab portion.

The removable panel may be removed from the parent panel by removing/releasing the at least one tab portion from the parent panel. Accordingly, when the removable panel is removed/released from the parent panel, a panel opening is exposed within the parent panel which extends through the parent panel in a shape of the removable panel, and the at least one gap forms an outer periphery of the panel opening.

The parent panel, the removable panel and the at least one tab portion may be formed of a same material.

The parent panel, the removable panel and the at least one tab portion, while attached, may form a one-piece integral construction.

Front and back surfaces of the parent panel, the removable panel and the at least one tab portion, while attached, may be formed in a same plane such that the front surfaces are planar with respect to each other and the back surfaces are planar with respect to each other.

According to another aspect of the present invention, there is provided a method of forming a removable panel within a parent panel, the method including: forming at least one gap in the parent panel such that the at least one gap is formed between the parent panel and the removable panel, and the at least one gap extends around an outer periphery of the removable panel except at an at least one tab portion, wherein the at least one tab portion adjoins the removable panel to the parent panel.

The removable panel may be configured to be removed from the parent panel by detaching the at least one tab portion from the parent panel.

The method may further include removing the removable panel from the parent panel by detaching the at least one tab portion from the parent panel.

The method may further include exposing a panel opening in the parent panel by removing the removable panel from the parent panel such that the panel opening is exposed within the parent panel and extends through the parent panel in a shape of the removable panel, and the at least one gap forms an outer periphery of the panel opening.

The parent panel, the removable panel and the at least one tab portion may be formed of a same material.

The parent panel, the removable panel and the at least one tab portion, while attached, may form a one-piece integral construction.

Front and back surfaces of the parent panel, the removable panel and the at least one tab portion, while attached, may be formed in a same plane such that the front surfaces are planar with respect to each other and the back surfaces are planar with respect to each other.

### BRIEF DESCRIPTION OF THE DRAWINGS

Aspects of the present invention will become more apparent by describing in detail examples of embodiments thereof with reference to the accompanying drawings, in which:

FIGS. 1A-C show various methods used to plug, cover or make use of panel openings using fill-in plugs, blanks or fittings according to the related art.

FIGS. 2A-C show a panel opening cover according to an exemplary embodiment of the general inventive concept.

FIG. 3 shows a panel opening with a panel cover removed according to an exemplary embodiment of the general inventive concept.

FIG. 4 shows a device inserted through a panel opening according to an exemplary embodiment of the general inventive concept.

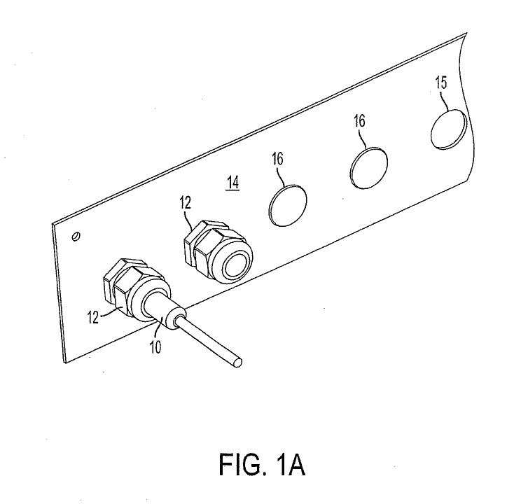

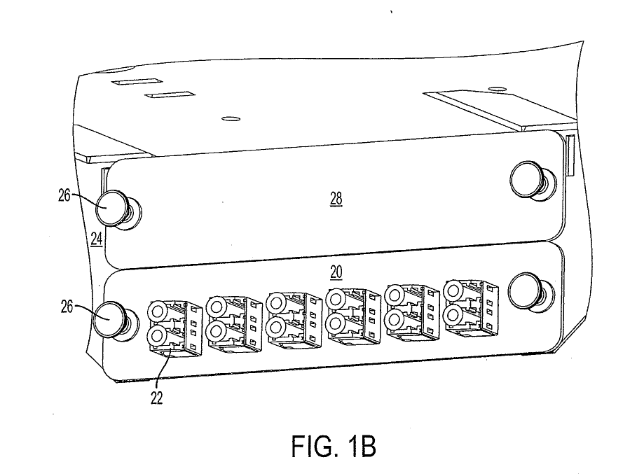

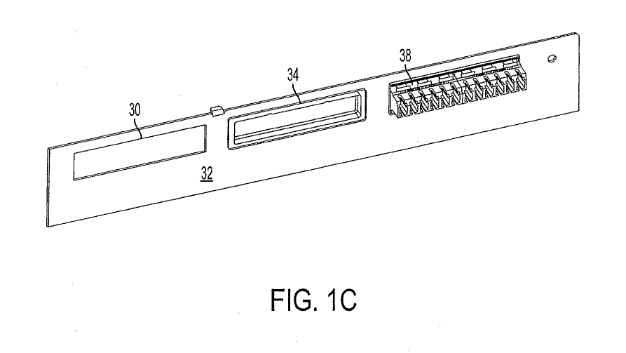

### DETAILED DESCRIPTION

The present invention will now be described more fully with reference to the accompanying drawings, in which examples of embodiments of the invention are shown. The invention may, however, be embodied in many different forms and should not be construed as being limited to the embodiments set forth therein; rather, these examples of embodiments are provided so that this disclosure will be thorough and complete, and will fully convey the concept of the invention to those skilled in the art.

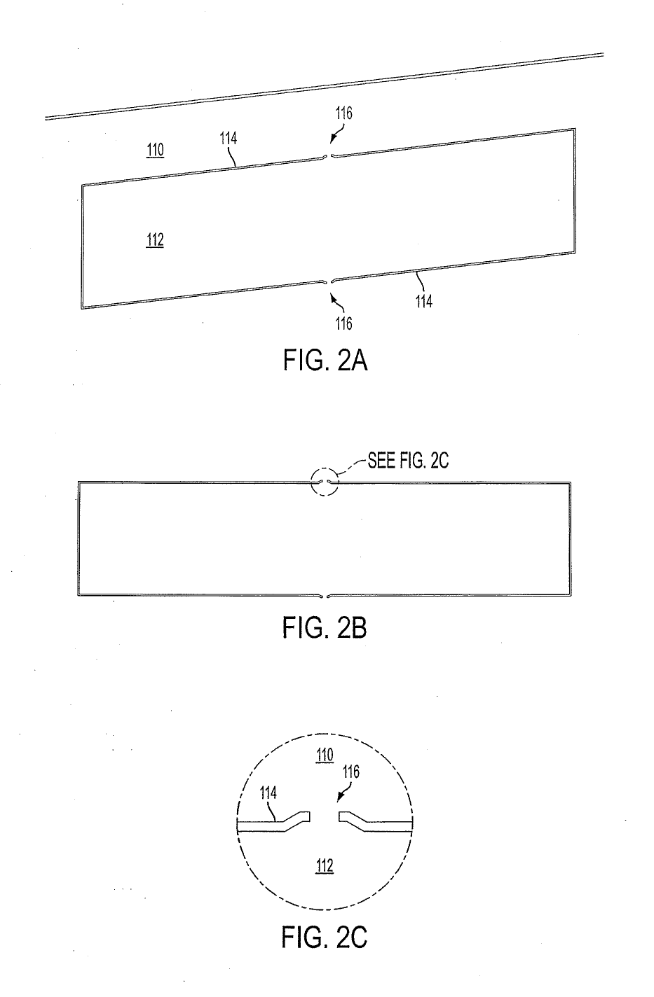

As shown in FIGS. 2-4, a parent material is used to keep openings covered until they are used (i.e., until the openings are populated). For example, the parent material is cut away to provide the opening except for one or more locations where the parent material remains or is not completely removed. The parent material that remains or that is not completely removed forms a removable panel which exposes an opening formed in the parent material when removed. The material of the removable panel remains at the same plane as the parent material. Accordingly, the end user may then use the opening by removing removable panel (i.e., the portion of the material that is covering the opening), and may populate the opening with adapters and various other hardware.

This does away with the added cost of any variation of plug or plate that is currently used to cover the opening. Furthermore, the design allows for a variation in the size, number and locations of the areas where the parent material remains or is not completely removed, and may facilitate the removal of the parent material that remains or is not completely removed.

FIG. 2A shows a panel opening cover according to an exemplary embodiment of the general inventive concept. In particular, FIG. 2 shows a parent panel 110 made of a parent material. A removable panel 112, also made of the parent material, is formed in the parent panel 110 such that at least one gap 114 between the removable panel 112 and the parent panel 110 is formed around the periphery of the removable panel 112, except at one or more tab portions 116. The gap 114, for example, may be formed by cutting away, or by some other removal method, the parent material from the parent panel 110 such that an outline of an opening is formed. Accordingly, the removable panel 112 is formed to occupy substantially all of the opening, except for area of the gap 114 which may be a slit or other small opening that extends through the parent panel 110.

Accordingly, the removable panel 112 is removably connected to the parent panel 110 via the tab portions 116, and while adjoined, the parent panel 110, the removable panel 112 and the tab portions 116 form a one-piece integral construction. Also, by using the parent material of the parent panel 110 as a platform for forming the removable panel 112, the removable panel 112 remains at the same plane as the parent panel 110.

FIGS. 2B and 2C show a view of one of the tab portions 116 with gap portions 114 on either side of the tab portion 116. The tab portion 116 forms a connect between the material of the parent panel 110 and the material of the removable panel 112. The removable panel 112 may be detached from the parent panel 110 by detaching each of the tab portions 116 from the parent panel 110. By adjusting the number of tab portions 116 and/or the thickness of each tab portion 116, the difficulty in removing the removable panel 112 can be adjusted. For example, by increasing the number of tab portions 116 and/or increasing the thickness of the tab portions 116, the removable panel 112 can be made more difficult to remove.

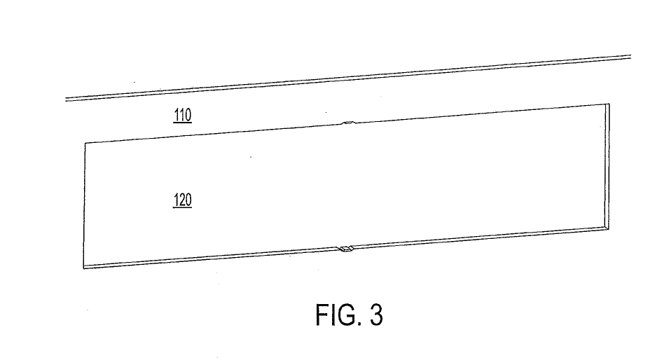

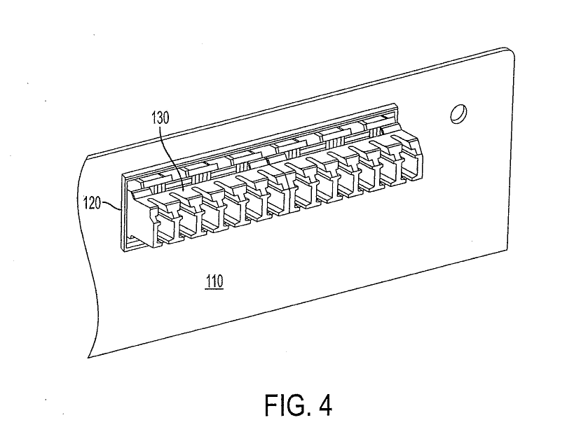

FIG. 3 shows a panel opening with a panel cover removed according to an exemplary embodiment of the general inventive concept. In particular, FIG. 3 shows a panel opening 120 formed within the parent panel 110 after removable panel 112 (not shown) is removed from the parent panel 110. Accordingly, when a removable panel 112 is removed by removing the tab portions 116 (not shown), the panel opening 120 is exposed having a shape of the removed removable panel 112. Thereafter, the panel opening 120 may be populated with an adapter and various other hardware. For example, FIG. 4 shows a device 130 inserted into a panel opening 120.

In view of the above, the removable panels formed from the parent material may provide a design that is cheaper than using plugs or cover plates to cover removed parent material. They also may eliminate the cost of lost or misplaced plugs or cover plates.

The removable panels may also be manufactured with a variable removal force, such that the amount of removal force required to remove the removable panel from the parent panel is adjusted to be higher or lower at the time of manufacturing. For example, the thickness or the number of the tab portions may be adjusted to adjust the removal force such that a larger thickness and/or larger number of tab portions increases the removal force.

The removable panels may also be painted and finished along with the main component, i.e., the parent panel.

Also, the panel opening may be formed such that no burrs or interruptions occur in the required shape of the opening.

Numerous modifications may be made to the examples of embodiments of the present invention discussed above without departing from the spirit and scope of the present invention as defined by the following claims.

What is claimed is:

1. A panel comprising:
a parent panel;
a removable panel formed from the parent panel and configured to be removed from the parent panel;
at least one tab portion which adjoins the removable panel to the parent panel; and
at least one gap formed between the parent panel and the removable panel, the at least one gap extending around an outer periphery of the removable panel, except at the at least one tab portion.

2. The panel of claim 1, wherein the removable panel is removed from the parent panel by removing the at least one tab portion from the parent panel.

3. The panel of claim 1, wherein, when the removable panel is removed from the parent panel, a panel opening is exposed within the parent panel and extends through the parent panel in a shape of the removable panel and the at least one gap forms an outer periphery of the panel opening.

4. The panel of claim 1, wherein the parent panel, the removable panel and the at least one tab portion are formed of a same material.

5. The panel of claim 1, wherein the parent panel, the removable panel and the at least one tab portion, while attached, faun a one-piece integral construction.

6. The panel of claim 5, wherein front and back surfaces of the parent panel, the removable panel and the at least one tab portion, while attached, are formed in a same plane.

7. The panel of claim 5, wherein front and back surfaces of the parent panel, the removable panel and the at least one tab portion, while attached, are planar with respect to each other.

8. A method of forming a removable panel within a parent panel, the method comprising:
forming at least one gap in the parent panel such that the at least one gap is formed between the parent panel and the removable panel, and the at least one gap extends around an outer periphery of the removable panel except at an at least one tab portion,
wherein the at least one tab portion adjoins the removable panel to the parent panel.

9. The method of claim 8, wherein the removable panel is configured to be removed from the parent panel by detaching the at least one tab portion from the parent panel.

10. The method of claim 8, further comprising removing the removable panel from the parent panel by detaching the at least one tab portion from the parent panel.

11. The method of claim 10, further comprising exposing a panel opening in the parent panel by removing the removable panel from the parent panel such that the panel opening is exposed within the parent panel and extends through the parent panel in a shape of the removable panel and the at least one gap forms an outer periphery of the panel opening.

12. The method of claim 8, wherein the parent panel, the removable panel and the at least one tab portion are formed of a same material.

13. The method of claim 8, wherein the parent panel, the removable panel and the at least one tab portion, while attached, form a one-piece integral construction.

14. The method of claim 13, wherein front and back surfaces of the parent panel, the removable panel and the at least one tab portion, while attached, are formed in a same plane.

15. The method of claim 13, wherein front and back surfaces of the parent panel, the removable panel and the at least one tab portion, while attached, are planar with respect to each other.
